(19) United States
(12) Patent Application Publication
(10) Pub. No.: US 2006/0217585 A1
(43) Pub. Date: Sep. 28, 2006

(54) Method for stabilization of arsenic bearing waste or material

(76) Inventor: Keith Edward Forrester, Meredith, NH (US)

Correspondence Address: Keith E. Forrester, 78 Tracy Way, Meredith, NH, 03253, US

(21) Appl. No.: 11/389,408

(22) Filed: Mar. 25, 2006

Related U.S. Application Data
(60) Provisional application No. 60/665,764, filed on Mar. 28, 2005.

(51) Int. Cl. B09B 3/00

(52) U.S. Cl. 588/256

(57) ABSTRACT

This invention provides a method for stabilization of arsenic bearing materials and wastes subject to acid and water leaching tests or leach conditions by addition of stabilizing agents such that the leaching potential is inhibited to desired levels and the material or waste is free flowing. The resultant material or waste after stabilization is deemed suitable for on-site reuse, off-site reuse or disposal as RCRA non-hazardous waste.

### BACKGROUND OF THE INVENTION

Over the past thirty years, the potential and observed dangers of heavy metal bearing materials and waste exposure to humans and the environment has been the basis of extensive regulatory control. The leaching and transport of heavy metals into surface water bodies and groundwater is a grave concern because of the danger that the drinking water supplies and the environment will become contaminated. Heavy metal bearing materials and wastes, such as soils contaminated with industrial or commercial products or waste, paint residues, sludge, sediments, foundry dusts, casting sands, steel mill dusts, shredder residues, wire insulation, refuse incinerator flyash, incinerator bottom ash, scrubber residues from air pollution control devices such as cyclones, electrostatic precipitators and bag-house filter bags, may be deemed hazardous by the United States Environmental Protection Agency (U.S. EPA) pursuant to 40 C.F.R. Part 261 if containing certain soluble heavy metals above regulatory limits. Any solid waste can be defined as hazardous either because it is “listed” in 40 C.F.R., Part 261 Subpart D or because it exhibits one or more of the characteristics of a hazardous waste as defined at Part 261, Subpart C. These characteristics are: (1) ignitability, (2) corrosivity, (3) reactivity, and (4) toxicity as tested under the Toxicity Characteristic Leaching Procedure (TCLP).

40 C.F.R., Part 261.24(a), contains a list of contaminants and their associated maximum allowable concentrations. The inorganic list includes As, Ag, Ba, Cd, Cr, Pb, Hg, and Se. If a contaminant, such as arsenic, exceeds its maximum allowable concentration, when tested using TCLP analysis as specified at 40 C.F.R. Part 261 Appendix 2, then the material is classified as hazardous. The TCLP test uses a dilute acetic acid either in deionized water (TCLP fluid 2) or in deionized water with a sodium hydroxide buffer (TCLP fluid 1). Both extracts attempt to simulate the leachate character from a decomposing trash landfill in which the hazardous waste being tested for is assumed to be disposed of in, and thus subject to the acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for defined metals. The TCLP test is designed to simulate a worst-case leaching situation, that is leaching conditions which would typically be found in the interior of an actively degrading municipal landfill. Such landfills normally are slightly acidic with a pH of approximately 5+0.5. Countries outside of the US also use the TCLP test as a measure of leachablity such as Taiwan and Canada. Thailand also limits solubility of Cu and Zn, as these are metals of concern to Thailand groundwater. Switzerland regulates management of solid wastes by measuring heavy metals and salts as tested by a sequential leaching method using carbonated water simulating rainwater. Japan, Mexico and the United Kingdom use similar DI water leach tests to measure for heavy metals.

Additionally, U.S. EPA land disposal restrictions prohibit the land disposal of treated hazardous wastes which leach in excess of maximum allowable concentrations upon performance of the TCLP analysis. The land disposal regulations require that hazardous wastes are treated until the heavy metals do not leach at UTS levels from the solid waste at levels above the maximum allowable concentrations prior to placement in a surface impoundment, waste pile, landfill or other land disposal unit as defined in 40 C.F.R. 260.10.

Leach test conditions thus include the conditions to which a sludge, ash, waste, material or soil is subjected during dilute acetic acid leaching (TCLP), buffered citric acid leaching (STLC), distilled water, synthetic rainwater or carbonated water leaching (US SPLP, Japanese, UK, Swiss, and USEPA SW-924).

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered acetic acid for 18 hours. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO2 saturated method is the Swiss protocol using 100 grams of cemented waste at 1 cm3 in two (2) sequential water baths of 2000 ml. The concentration of heavy metals and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached heavy metal is then analyzed by Inductively-Coupled Plasma (ICP) after filtration of a 100 ml aliquot from the tumbler through a 45 micron glass bead filter.

Of specific interest and concern regarding the present invention is the leaching of total measured Arsenic, commonly in a reduced form as Arsenite (As+3) or the oxidized form as Arsenate (As+5), under TCLP, SPLP, CALWET, DI, rainwater and surface water conditions as well as non-landfill conditions such as open industrial sites, waste storage cells, waste piles, waste monofills and under regulatory tests which attempt to simulate water leaching for determination of hazardousness of any given soil, material or waste.

The present invention provides a method of reducing the leachability of total As under TCLP, SPLP, CALWET, DI, rainwater and surface water leaching conditions as well as under regulatory water extraction test conditions as defined by waste control regulations in UK, Thailand, Japan, Switzerland, Germany, Sweden, The Netherlands and under American Nuclear Standards for sequential leaching of wastes by deionized water, while maintaining the stabilized material or waste pH between 2.0 and 12.5 as measured under EPA Method 9045C in order to meet local and state landfill pH disposal limitations, and producing a stabilized material or waste suitable for excavator or loader loading, truck unloading and land disposal or reuse spreading and compaction.

Unlike the present invention, prior art additives have focused on reducing the solubility of arsenic using Portland cement and Portland cement combinations with stabilizing agents to produce a reduced permeability matrix or solid material form which present post-stabilization handling and disposal complications, whereas the present invention use of zero to low dosage cement, cement kiln dust, or lime in combination with heavy metal stabilizers acts to reduce metals solubility without significant reduction of waste permeability and without formation of cement-like non-free flowing stabilized waste.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial waste water contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

Unlike the present invention, however, none of the prior art solutions were designed to allow specifically for stabilization of arsenic waste while also meeting landfill pH restrictions and forming a free-flowing and permeable stabilized matrix suitable for loading, transport, disposal and reuse without having a cement-like reduced permeability and strength.

### SUMMARY OF THE INVENTION

The present invention discloses an arsenic bearing material or waste stabilization method through contact of material or waste with stabilizing agents including Portland cement, cement kiln dust, lime kiln dust, dolomitic lime, ferric chloride, ferric sulfate, iron chelate, iron oxides, iron powder and combinations thereof which are properly chosen to complement the material or waste constituency and desired free-flowing and permeable material or waste handling characteristics. The stabilizing agents proven effective are provided in both in dry and wet chemical form, and thus can be contacted with heavy metal bearing material either prior to waste production such as in-stream at wastewater facilities producing sludge or in-duct prior to air pollution control and ash collection devices or after waste production in material collection devices or waste piles.

It is anticipated that the stabilizers can be used for both RCRA compliance actions such that generated wastes or materials from wastewater facilities, furnaces, incinerators and other facilities do not exceed the TCLP hazardous waste criteria under TCLP or CERCLA (Superfund) response where stabilizers are added to waste piles or storage vessels previously generated. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit.

### DETAILED DESCRIPTION

Environmental regulations throughout the world such as those promulgated by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a low soluble form, thus passing leach tests and allowing the wastes to be either reused on-site or disposed at local landfills without further and more expensive control means such as hazardous waste disposal landfills or facilities designed to provide metals stabilization. The present invention discloses an arsenic bearing material or waste stabilization method through contact of material or waste with stabilizing agents including Portland cement, cement kiln dust, quicklime, dolomitic lime, lime, lime kiln dust, ferric sulfate, ferric chloride, iron chelate, iron oxide, iron powder and combinations thereof. The stabilizing agents found effective are available in dry, slurry and wet chemical form, and thus can be contacted with heavy metal bearing material prior to waste generation such as in-stream at wastewater sludge producing plants or in-duct prior to air pollution control and ash collection devices or after waste production in collection devices such as hoppers, dump valves, conveyors, dumpsters or waste piles. The stabilizers are applied in a manner to utilize Portland cement and/or cement kiln dust as a heavy metals stabilizing agent and not as a cementing additive, thus allowing stabilized material and waste to remain suitable for fill material or loose handling and to remain permeable thus allowing for transmission of leachate or water flow. The transmission of water flow becomes important an necessary when using the stabilized waste or material as base fill, cover, embankment or engineered fill, thus eliminating damming or leachate production perched water table effects.

It is anticipated that the stabilizers can be used for both RCRA compliance actions such that generated materials from mining operations, wastewater facilities, furnaces, incinerators and other facilities do not exceed appropriate TCLP hazardous waste criteria under TCLP, or used for CERCLA (Superfund) response where stabilizers are added to waste piles or storage vessels previously generated and now regulated under RCRA as a hazardous waste pre-disposal. The preferred method of application of stabilizers would be in-line within the property and facility generating the heavy metal bearing material, and thus allowed under RCRA as a totally enclosed, in-tank or exempt method of TCLP stabilization without the need for a RCRA Part B hazardous waste treatment and storage facility permit(s).

The use of Portland cement, cement kiln dust, lime kiln dust, quicklime, lime, ferric sulfate, ferric chloride, iron chelate, iron oxide, iron powder and combinations would, as an example, provide various amount of cement, cement kiln dust, lime kiln dust, lime, ferric chloride, ferric sulfate, iron chelate, iron oxide, iron powder and or combination contact with material or waste. The cement, cement kiln dust, lime kiln dust, lime, ferric chloride, ferric sulfate, iron chelate, iron oxide, iron powder and combination type, size, dose rate, contact duration, and application means could be engineered for each type of heavy metal bearing material or waste.

Although the exact stabilization formation molecule(s) are unknown at this time, it is expected that when heavy metals comes into contact with the stabilizing agent(s), low water and low acid soluble compound(s) begin to form such as a mineral ferric arsenate and ferric substitutes less soluble than the heavy metal element or molecule originally in the material or waste. It also remains possible that modifications to temperature and pressure may accelerate of assist formation of minerals, although such methods are not considered optimal for this application given the need to limit cost and provide for optional field based stabilizing operations that would be complicated by the need for pressure and temperature control devices and vessels.

Examples of suitable stabilizing agents include, but are not limited to, Portland cement, cement kiln dust, lime kiln dust, ferric sulfate, ferric chloride, calcium oxide (quicklime), dolomitic quicklime, iron chelate, iron oxide, iron powder. The amounts of stabilizing agent used, according to the method of invention, depend on various factors including desired solubility reduction potential, desired mineral toxicity, and desired mineral formation relating to toxicological and site environmental control objectives. It has been found that an amount of certain stabilizing agents such as 10% cement and 2% ferric chloride 30% solution, by weight of waste is sufficient for initial TCLP stabilization to less than RCRA limits. However, the foregoing is not intended to preclude yet higher or lower usage of stabilizing agent or combinations if needed since it has been demonstrated that amounts greater than 15% cement kiln dust and also work, but are more costly. The examples below are merely illustrative of this invention and are not intended to limit it thereby in any way.

### EXAMPLE 1

In this example Arsenic bearing sediment from California was stabilized with varying amounts of stabilizing agents including Iron Powder—20 mesh (IP), Ferric Chloride (FC) 30% solution, Ferric Sulfate 10% (FS) solution, Iron Chelate 3.2% solution (IC), Portland Cement Type 1/11 (PC), and Dolomitic Quicklime (DQ), with zero days of sample curing pre-extraction. Both stabilized and un-stabilized sediment were subsequently tested for STLC extract Arsenic content. Samples were extracted according to CALWET. The leachate was digested prior to analysis by ICP. Cement, lime, iron precipitates and waste mixtures produced free flowing sediment with less than 20 PSI unconfined strength at 3 days curing.

TABLE 1

| | | |
|---|---|---|
| Stabilizer Dose (%) | STLC As (ppm) | TCLP As (ppm) |

| | | |
|---|---|---|
| Sediment Baseline - CA | 13 | 6.7 |
| 10 FS | 13 | 3.2 |
| 10 FC | 14 | 3.4 |
| 10 IP | 2.2 | 1.2 |
| 15 PC + 2 FS | 4.5 | 2.4 |
| 15 PC + 2 FC | 3.4 | 1.6 |
| 10 DQ + 2 FS | 2.4 | 1.6 |
| 10 DQ + 2 FC | 2.4 | 1.2 |

### EXAMPLE 2

In this example smelter slag from Mexico City was stabilized with quicklime and iron powder with 0 days of sample curing pre-extraction. Both stabilized and un-stabilized slag was subsequently tested for water leachable As. Samples were extracted according to the USEPA method 1312 SPLP. The leachate was digested prior to analysis by ICP. Stabilized slag had less than 10 PSI unconfined strength. Permeability was measured at greater than 10-2 cm/sec.

TABLE 2

| Stabilizer Dose (%) | SPLP As (ppm) |
|---|---|
| Baseline | 1500 |
| 50 IP + 10 DQ | <0.05 |

The foregoing results in Table 1 and 2 readily established the operability of the present process to stabilize As thus reducing solubility, measured leachability and bioavailability. Given the effectiveness of the stabilizing agents in causing combined heavy metals to stabilize as presented in the Table 1 and 2, it is believed that an amount of the stabilizing agents equivalent to less than 5% by weight of heavy metal bearing material or waste should be effective. It is also apparent from the Table 1 and 2 results that certain stabilizing agents and complexing blends are more effective for stabilization.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of arsenic bearing material or waste, comprising contacting arsenic bearing material or waste with at least one stabilizing agent in an amount effective in reducing the leaching of combined heavy metals from the material or waste to a level no more than non-hazardous levels as determined in an EPA TCLP test, performed on the stabilized material or waste, as set forth in the Federal Register, vol. 55, no. 126, pp. 26985-26998 (Jun. 29, 1990).

2. The method of claim 1, wherein the stabilizing agent is selected from the group consisting of cement kiln dust, lime kiln dust, Portland cement, quicklime, lime, ferric sulfate, ferric chloride, iron chelate, iron oxide, iron powder, iron flake, and combinations thereof.

7. The method of claim 1 wherein Arsenic bearing material or waste is contacted with at least on stabilizing agent in effective amount to reduce leaching to TCLP non-hazardous or desired levels prior to collection of such material or waste in containers.

8. The method of claim 1 wherein Arsenic bearing material or waste is contacted with at least on stabilizing agent in effective amount to reduce leaching to TCLP non-hazardous or desired levels during or after collection of such material or waste in containers or during or after generation of material or waste as a regulated waste.

9. A method of reducing the solubility of arsenic bearing material or waste, comprising contacting arsenic bearing material or waste with at least one stabilizing agent in an amount effective in reducing the leaching of combined heavy metals from the material or waste to a level no more than non-hazardous levels as determined in SPLP, United Kingdom DI, Japan DI or Swiss sequential water leach test, performed on the stabilized material or waste.

10. The method of claim 9, wherein the stabilizing agent is selected from the group consisting of Portland cement, cement kiln dust, lime, ferric chloride, ferric sulfate, iron chelate, iron oxide, iron powder, iron flake and combinations thereof.

11. The method of claim 1 wherein Arsenic bearing waste or material is contacted with at least on stabilizing agent in effective amount to reduce water leaching to non-hazardous or desired levels prior to collection of such waste or material in containers.

12. The method of claim 1 wherein Arsenic bearing waste or material is contacted with at least on stabilizing agent in effective amount to reduce water leaching to non-hazardous or desired levels during or after collection or during or after generation of such waste or material.
